(19) United States
(12) Patent Application Publication
(10) Pub. No.: US 2026/0220929 A1
(43) Pub. Date: Jul. 30, 2026

(54) EFFICIENT VISION TRANSFORMER ARCHITECTURE WITH OPTIMIZED TOKEN PROCESSING

(71) Applicant: QUALCOMM Incorporated, San Diego, CA (US)

(72) Inventors: Ramanan Sekar, San Jose, CA (US); Soyeb Noormohammed Nagori, San Diego, CA (US)

(21) Appl. No.: 19/038,493

(22) Filed: Jan. 27, 2025

(51) Int. Cl. G06V 10/82; G06V 10/26; G06V 10/764; G06V 10/776

(52) U.S. Cl. CPC G06V 10/82; G06V 10/764; G06V 10/776; G06V 10/273

(57) ABSTRACT

A vision transformer architecture processes images while improving hardware utilization through selective token handling. Described architectures receives input images, generates image tokens, and processes the tokens through transformer layers without requiring a classification token. An adapter layer, trained using vector comparisons between outputs with and without classification tokens, enables this efficient processing while maintaining accuracy. The adapter layer integrates with existing model weights and can merge with downstream processing layers. This approach addresses computational inefficiencies in vision transformer models when used primarily as encoders rather than classifiers. Implementations can be utilized in vision-language models for autonomous driving, mobile applications, and data center operations where processing efficiency impacts system performance.

### TECHNICAL FIELD

This disclosure relates generally to artificial intelligence processing, and more specifically, to transformer architectures for accelerated hardware processing of vision-language models.

### BACKGROUND

Vision transformer models have emerged in computer vision systems for processing visual information in vision-language models (VLMs). The models typically incorporate both image-specific tokens and a supplemental classification token as part of their processing pipeline. The classification token, originally designed to aggregate image-wide information for classification tasks, has become a standard component of vision transformer architectures. In conventional implementations, vision transformers process input images by first dividing them into patches, converting the patches into image tokens, and appending a classification token to this sequence. The entire token sequence, including both image tokens and the classification token, then passes through multiple transformer layers that apply self-attention mechanisms and neural network operations. This approach has proven effective for image classification tasks where the classification token serves as an aggregation point for making classification decisions.

However, many modern applications, particularly in autonomous driving, mobile device communications, and data center applications, utilize vision transformers primarily as feature extractors or encoders rather than classifiers. In such scenarios, the downstream tasks typically discard the classification token and use only the processed image tokens. Despite this token's irrelevance to the final output, conventional architectures continue to allocate computational resources to process it through all transformer layers. This inefficiency introduces at least two challenges. First, processing an unnecessary classification token consumes computational resources without contributing to the final output, which creates unnecessary overhead in processing time and energy consumption. Second, and perhaps more critically, inclusion of the additional token often results in non-factorizable dimensions in the computational pipeline, which makes it difficult to efficiently map operations to modern hardware accelerators.

Current approaches to addressing the foregoing inefficiencies typically involve complete model retraining or architectural modifications that significantly impact model accuracy. Such solutions often require substantial computational resources for retraining and may not maintain the model's original performance characteristics. Also, existing methods frequently fail to address the hardware mapping challenges that arise from non-factorizable dimensions—leaving a gap in practical deployment scenarios. As such, a solution is needed that can efficiently process vision transformer models without the classification token while maintaining model accuracy and enabling optimal hardware utilization.

### SUMMARY

The following summarizes some aspects of this disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in an apparatus. The apparatus includes a processor configured to receive an input image, generate a plurality of image tokens from the input image, process only the plurality of image tokens through a vision transformer that includes at least one trained adapter layer, and generate output data from the processed plurality of image tokens.

In some implementations, the at least one trained adapter layer merges with a downstream processing adapter layer, allowing for streamlined computational paths. In some implementations, the vision transformer includes a plurality of transformer layers, where additional adapter layers can be selectively added to the transformer layers based on accuracy measurements during operation. The transformer layers may maintain fixed parameters during operation, ensuring stability in the processing pipeline. The processing may include omitting supplemental classification tokens from the vision transformer processing, reducing computational overhead. In some implementations, the processor generates the plurality of image tokens using a patchify operation, enabling efficient image tokenization.

Another innovative aspect can be implemented in an apparatus for training vision transformers. The apparatus includes a processor configured to receive a plurality of image tokens from an input image and generate, using a pretrained vision transformer, two output vector sets: a first set comprising a plurality of image token outputs and a supplemental token output, and a second set comprising the plurality of image token outputs. The processor trains at least one adapter layer using a vector comparison metric between these output vector sets and stores the trained adapter layer for subsequent processing operations.

In some examples, the processor monitors accuracy of the pretrained vision transformer and incorporates additional adapter layers among transformer layers responsive to accuracy measurements. The processor maintains fixed parameters of the pretrained vision transformer during adapter layer training, preserving pretrained model knowledge. In some implementations, the vector comparison metric comprises a mathematical difference between the plurality of image token outputs from both vector sets. The processor may generate tokens using learnt patchify parameters from the pretrained vision transformer and merge the trained adapter layer with existing downstream processing layers.

Another innovative aspect can be implemented in a method for vision transformer processing. The method includes receiving an input image, generating a plurality of image tokens from the input image, processing only these tokens through a vision transformer including at least one trained adapter layer, and generating output data from the processed tokens.

In some implementations, the method includes merging the trained adapter layer with a downstream processing adapter layer. The vision transformer may comprise multiple transformer layers that maintain fixed parameters during operation. The trained adapter layer may employ vector comparison metrics between different output vector sets. In some examples, the method includes generating tokens through patchify operations, producing perception data specifically for autonomous vehicle applications, and implementing accuracy monitoring with dynamic adapter layer incorporation.

Approaches described herein provides advantages for real-world applications. By removing unnecessary token processing while maintaining model accuracy through controlled adaptation, the system achieves improved hardware utilization and processing efficiency. This is particularly valuable in autonomous driving, mobile applications, and data center operations where processing speed and resource utilization directly impact system performance.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of this disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system that supports efficient vision transformer operations according to one or more aspects.

FIG. 2 shows a block diagram of an example base station and user equipment supporting vision transformer optimization according to one or more aspects.

FIG. 3 shows a block diagram of an example processing system incorporating artificial intelligence acceleration capabilities according to one or more aspects.

FIG. 4 is a flow diagram illustrating an example process for efficient vision transformer operations through selective token processing according to one or more aspects.

FIG. 5 illustrates a block diagram of an example apparatus that implements vision transformer operations with selective token processing according to one or more aspects.

FIG. 6 is a flow diagram illustrating an example process for training vision transformers using controlled-invariance adaptation according to one or more aspects.

FIG. 7 illustrates a block diagram of an example apparatus that implements vision transformer training with controlled-invariance adaptation according to one or more aspects.

Reference is made to the figures wherein like numerals refer to like parts throughout. The figures are not necessarily to scale, and the skilled artisan will appreciate that certain feature(s) may be exaggerated for clarity, dimensioning, and ease of understanding.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Vision transformer architectures are powerful tools for processing visual information in modern artificial intelligence systems, e.g., particularly in vision-language models and autonomous systems. The architectures traditionally incorporate both image-specific tokens and supplemental classification tokens during processing where the classification token serves as an aggregation point for image-wide information. Approaches described herein process visual data through vision transformers without requiring classification tokens while maintaining model accuracy through controlled adaptation techniques that optimize hardware utilization and processing efficiency.

Described techniques employ adapter layers trained using precise vector comparison metrics between outputs generated with and without classification tokens. Through this controlled-invariance training approach the system achieves efficient processing while preserving the underlying transformer's pretrained capabilities. Implementations can involve generating image tokens from input images using established patchify operations, processing these tokens through vision transformers with trained adapter layers, and producing output data suitable for downstream applications such as perception and scene understanding.

More specifically, described techniques can maintain fixed parameters in the pretrained vision transformer while training adapter layers to compensate for removed classification tokens. The adapter layers, which may be incorporated at various points in the transformer architecture, can be trained using a consistency loss based on mathematical differences between output vectors. The training process enables the system to process only image-specific tokens while achieving comparable results to traditional approaches that require classification token computation. As such, described architectures supports dynamic incorporation of additional adapter layers based on accuracy measurements, providing flexibility in balancing performance and computational efficiency.

Aspects described herein allow for integration with existing vision processing pipelines through merger capabilities between trained adapter layers and downstream processing components. This integration approach maintains the benefits of efficient token processing while avoiding computational overhead in the processing chain overall. Further, described aspects support monitoring and adaptation of the transformer's accuracy to allow for dynamic adjustment of the processing pipeline to maintain optimal performance across varying operational conditions and requirements.

Particular implementations of the subject matter described in this disclosure may be implemented to realize one or more of the following potential advantages or benefits. In some aspects, the present disclosure provides techniques for accelerating vision transformer processing while maintaining accuracy through selective token handling and controlled adaptation. Processing only image-specific tokens reduces computational overhead and memory requirements during inference, thereby enabling more efficient hardware utilization without sacrificing the model's ability to extract meaningful features from visual inputs.

By employing adapter layers trained with vector comparison metrics, described architectures achieve equivalent functionality without requiring full model retraining. The controlled-invariance training approach preserves the pretrained model's capabilities while enabling more efficient processing paths. Also, this requires minimal additional training data and compute resources compared to traditional retraining methods, which makes it suitable for resource-constrained environments and rapid deployment scenarios. Further, the ability to maintain fixed parameters in the pretrained transformer while adapting processing behavior through targeted layer training provides a foundation for deployment across different hardware platforms and operational requirements. Described architectures' ability to merge adapter layers with downstream processing components prevents accumulation of computational overhead in the processing pipeline. Vision transformer implementations utilizing this approach achieve improved hardware mapping through factorizable dimensions because the removal of supplemental tokens eliminates irregular computational patterns that traditionally challenge efficient hardware utilization. These improvements benefit applications requiring real-time visual processing, such as autonomous systems and mobile devices where processing efficiency directly impacts system performance and power consumption.

Support for dynamic accuracy monitoring and adapter layer incorporation as described herein provides operational flexibility while maintaining processing efficiency. Such adaptability enables deployment across diverse use cases with varying accuracy requirements, e.g., from high-precision autonomous vehicle perception to resource-constrained mobile applications. The ability to balance computational efficiency with accuracy through controlled adaptation represents a significant advancement in practical vision transformer deployment.

In view of the foregoing, described approaches enable efficient processing of visual information while maintaining compatibility with existing vision-language models and processing pipelines. By removing unnecessary computation associated with classification tokens while preserving model accuracy through controlled adaptation, tangible benefits in processing speed and hardware utilization are established. A selective token processing approach, as described herein, combined with controlled adaptation through adapter layers, provides a practical solution for deploying vision transformers in resource-constrained environments. Also, implementation flexibility through dynamic adapter layer incorporation enables fine-tuned balance between processing efficiency and accuracy requirements.

In various implementations, a processing system can be configured to adapt vision transformer architectures through controlled-invariance training techniques. The processing system can implement this adaptation while retaining pretrained model parameters, which eliminates the need for complete model retraining. Rather than utilizing post-processing techniques that may compromise accuracy, the processing system can be configured to adapt the model through targeted retraining using a specific methodology that can maintain computational efficiency. Here, a training component of the processing system can be configured to generate two distinct sets of output vectors using a subset of training data and a pretrained vision transformer. The first set can include output vectors maintaining the full token length n, incorporating both image tokens and the classification token. The second set can be configured to contain output vectors with the classification token removed, resulting in a length of n−1. This dual-vector generation approach can enable the system to establish a baseline for maintaining processing accuracy while eliminating unnecessary computation.

The processing system can be configured to implement a consistency loss function for training, defined as L=∥Xₙ[0:n−1]−Xₙ₋₁∥², where Xₙ represents the full-length output vectors and Xₙ₋₁ represents the vectors with the classification token removed. This mathematical formulation enables the system to maintain processing accuracy while eliminating the computational overhead associated with classification token processing. In some implementations, the consistency loss can be calculated across different subsets of the output vectors to optimize training efficiency.

Rather than implementing full model retraining, which can require substantial computational resources and training data, implementations of the processing system can be configured to incorporate adapter layers based on accuracy requirements. When, e.g., accuracy measurements indicate the need for additional adaptation, the processing system can add adapter layers among the transformer layers while maintaining fixed parameters in the base model. Each added adapter layer can be trained using the consistency loss function to enable optimization without compromising the pretrained model's capabilities. In implementations where accuracy requirements necessitate additional adaptation, the processing system can be configured to incorporate multiple adapter layers at selected positions within the transformer architecture, each trained using the consistency loss function while maintaining fixed parameters in the base model.

The processing system can also be configured to monitor accuracy metrics during training and deployment to enable dynamic adaptation based on operational requirements. In some implementations, the system can incorporate additional adapter layers responsive to accuracy measurements falling below specified thresholds. Such an adaptive approach enables the system to maintain optimal performance across varying operational conditions while minimizing computational overhead.

In various implementations, the adapter layers can be configured to merge with existing downstream processing components, preventing accumulation of computational overhead in the processing pipeline. The processing system can implement this merger while maintaining the benefits of efficient token processing, enabling seamless integration with existing vision processing architectures. This integration capability can be particularly beneficial in implementations requiring real-time processing or operating under resource constraints.

The processing system can further be configured to implement the adapter layer training using the controlled-invariance approach described in described architectures. In some implementations, the system can optimize the adapter layer parameters using the consistency loss function while maintaining fixed parameters in the pretrained transformer components. The training approach can be selected based on factors including but not limited to available computational resources, training data characteristics, and accuracy requirements.

Further, described architectures can leverage standard vision transformer token generation approaches, e.g., established patchify operations from pretrained transformers. While utilizing these standard patchify operations for initial token generation, the processing system introduces innovations in how these tokens are subsequently processed—specifically, eliminating classification token handling while maintaining accuracy through selective adapter layer incorporation. This approach preserves the proven benefits of standard transformer token generation while enabling more efficient processing pathways

At least one implementation of architectures described herein can be configured to support various configuration modes for data preprocessing and selection during controlled-invariance training. Such implementations can be configured to implement intelligent sampling strategies that balance representation across visual domains and scenarios. In some aspects, the sampling approach can be configured to ensure robust adaptation while minimizing training data requirements across diverse operational conditions. Further, some implementations can be configured to employ configurable thresholds governing accuracy monitoring and architectural adaptation during deployment. Such systems can be configured to dynamically adjust these thresholds based on application-specific requirements, thereby enabling fine-grained control over processing efficiency and model performance balance. In various implementations, the system can maintain separate thresholds for different processing stages, which can be configured to enable targeted optimization of specific transformer components.

A parameter management system can be configured to maintain optimal performance during adaptation to changing operational requirements. During adapter layer training, such implementations can be configured to track and preserve parameters from the pretrained transformer, including but not limited to learned patchify operations and attention mechanisms.

Described architectures can be configured to implement multi-stage integration when incorporating adapter layers into existing pipelines. Such implementations can analyze computational patterns of downstream components to identify optimal merger points. In some aspects, the system can be configured to implement gradual integration of adapter layers, while maintaining continuous performance monitoring. Various implementations can prevent processing bottlenecks through this methodical approach while preserving efficient token handling benefits. Further, performance tracking implementations can be configured to extend beyond basic accuracy monitoring to encompass multiple metrics, including but not limited to processing latency, memory utilization, and hardware-specific efficiency measurements. Such systems can be configured to maintain historical performance data, enabling trend analysis and predictive adaptation before performance degradation occurs.

In various implementations, described architectures can also be configured to accommodate diverse input characteristics and operational constraints. When deployed in resource-constrained environments, such systems can be configured to automatically adjust adaptation strategies to prioritize processing efficiency while maintaining accuracy. Alternative implementations suitable for environments with abundant computational resources can be configured to employ more sophisticated adaptation techniques for maximum performance.

Aspects can be configured to implement advanced token processing capabilities beyond basic classification token removal. Such implementations can analyze token relationships and dependencies, enabling optimized processing paths that preserve essential information flow while eliminating redundant computation. Various aspects can also support nuanced adaptation strategies tailored to specific vision processing requirements.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

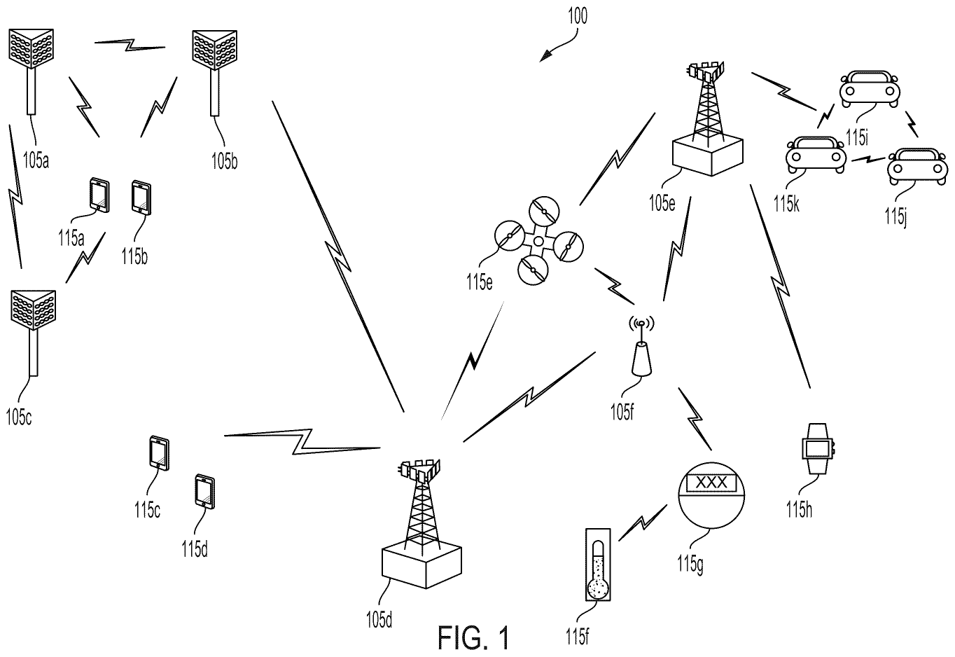

FIG. 1 is a block diagram illustrating details of an example wireless communication system according to one or more aspects. Wireless network 100 may, for example, include a 5G wireless network, which is particularly suitable for the low-latency communications required for efficient HD map data delivery to autonomous vehicles. As appreciated by those skilled in the art, components appearing in FIG. 1 are likely to have related counterparts in other network arrangements including, for example, cellular-style network arrangements and non-cellular-style-network arrangements (e.g., device-to-device or peer-to-peer or ad-hoc network arrangements, etc.).

Wireless network 100 illustrated in FIG. 1 includes nodes (e.g., communication nodes), such as base stations 105 and other network entities. A base station may be a station that communicates with the UEs and may also be referred to as an evolved node B (eNB), a next generation eNB (gNB), an access point, a node, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity. At least one of the base stations, such as base station 105d, may act as the gNB that implements the intelligent caching mechanism for HD map packets, while another network entity may represent the server that provides HD map data to the gNB.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of three-dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells. Base station 105d, acting as the gNB, could be a macro base station covering a large area to allow it to serve multiple autonomous vehicles efficiently with HD map data.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations. Flexibility in operation can be leveraged to ensure optimal delivery of HD map data to autonomous vehicles under various network conditions.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. UEs representing autonomous vehicles can be capable of requesting and receiving HD map data from the gNB, as well as communicating with the server through the gNB.

Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 115a-j are specifically shown as vehicles, a vehicle may employ the communication configuration described with reference to any of the UEs 115a-115k. Any of these vehicles can represent autonomous vehicles capable of establishing persistent connections with the gNB for ongoing exchange of HD map data during their trips.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100. UEs representing autonomous vehicles would be specifically configured to handle the exchange of HD map data with the gNB and the server.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links. Such communication links can include the transmission of HD map requests and data between autonomous vehicles and the gNB, as well as between the gNB and the server providing HD map data.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts. In an implementation, base station 105d, acting as the gNB, can also be responsible for caching HD map data received from the server and efficiently delivering it to autonomous vehicles.

Wireless network 100 supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e. Low-latency communication capability can be important for efficiently delivering HD map data to autonomous vehicles. Base station 105d, acting as the gNB, can implement the intelligent caching mechanism for HD map packets, serving autonomous vehicles (such as those represented by UEs 115i-115k) with cached geographic data. The V2V mesh network capabilities can potentially be leveraged for sharing or relaying HD map data between vehicles when direct communication with the gNB is not optimal.

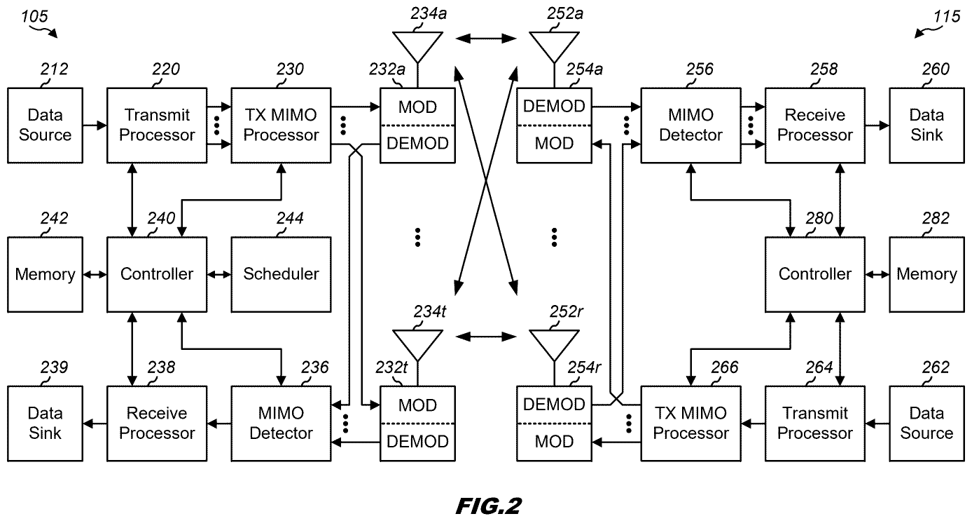

FIG. 2 depicts aspects of an example BS 110 and UE 120 that support low-latency geographic information packet fetching for autonomous vehicles. Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120, including HD map packets and related requests. BS 110 includes controller/processor 240, which may be configured to implement various functions described herein related to wireless communications, including the intelligent caching mechanism for HD map packets.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications, including requesting and processing HD map data for autonomous vehicle operation.

For an example downlink transmission, BS 110 (e.g., any network node) includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples, including HD map packets for autonomous vehicles.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS). Transmit processor 220 can facilitate transmitting a waveform to a UE or the like, and further facilitate transmitting frequency resource configuration information and/or time resource configuration information. These can be associated with HD map data transmission and the UE's capabilities for processing such data.

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively, and may include HD map data for autonomous vehicles.

UE 120 includes antennas 252a-252r that may receive the downlink signals from BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for UE 120 to a data sink 260, and provide decoded control information to a controller/processor 280. Receive processor 258 can facilitate the UE receiving frequency resource configuration information and/or time resource configuration information. Such configuration information can be associated with HD map data reception and processing for autonomous vehicle operation.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for single-carrier frequency division multiplexing (SC-FDM)), and transmitted to BS 110. Further, transmit processor 264 can facilitate transmitting requests for HD map data and location updates to a network node.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink, including scheduling the transmission of HD map data to autonomous vehicles.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, receive (RX) MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MTMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MTMO processor 266 may be performed by or under the control of the controller/processor 280.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station network node, or a network equipment may be implemented in an aggregated or disaggregated architecture. For example, a network node (such as a Node B (NB), an evolved NB (eNB), an NR BS, a 5G NB, an AP, a TRP, or a cell, among other examples), or one or more units (or one or more components) performing network node functionality, may be implemented as an aggregated network node (also known as a standalone network node or a monolithic network node) or a disaggregated network node. “Network entity” or “network node” may refer to a disaggregated network node, or to one or more units of a disaggregated network node (such as one or more CUs, one or more DUs, one or more RUs, or a combination thereof).

An aggregated network node (e.g., an aggregated network node) may be configured to utilize a radio protocol stack that is physically or logically integrated within a single RAN node (e.g., within a single device or unit). A disaggregated network node (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Network node-type operation or network design may consider aggregation characteristics of network node functionality. For example, disaggregated network nodes may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating network node functionality into one or more units that can be individually deployed. A disaggregated network node may include functionality implemented across two or more units at various physical locations, as well as functionality implemented for at least one unit virtually, which can enable flexibility in network design. The various units of the disaggregated network node can be configured for wired or wireless communication with at least one other unit of the disaggregated network node.

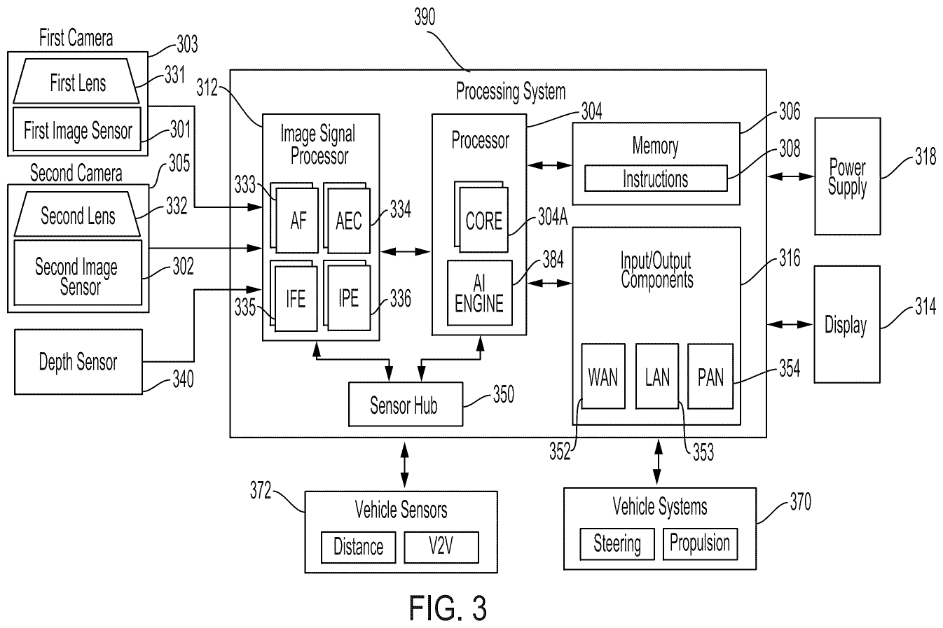

FIG. 3 shows a block diagram of an example processing system 390 associated with autonomous vehicles 115i-115k. Processing system 390 includes one or more processors (collectively “processor 304”), one or more memories (collectively “memory 306”), image signal processor 312, sensor hub 350, and Input/Output (I/O) components 316. Autonomous vehicles 115i-115k may include, or otherwise be coupled to, image signal processor 312 for processing image frames from one or more image sensors, such as first image sensor 301, second image sensor 302, and depth sensor 340. These sensors can contribute to the autonomous navigation capabilities and HD map data processing. In some implementations, autonomous vehicles 115i-115k also include or are coupled to a processor (e.g., CPU) 304 and memory 306 storing instructions 308. Autonomous vehicles 115i-115k may also include or be coupled to display 314 and input/output (I/O) components 316. I/O components 316 may be used for interacting with a user, such as a touch screen interface and/or physical buttons. I/O components 316 may also include network interfaces for communicating with other devices, such as other vehicles, an operator's mobile devices, and/or a remote monitoring system. The network interfaces may include one or more of wide area network (WAN) adaptor 352, local area network (LAN) adaptor 353, and/or personal area network (PAN) adaptor 354. An example WAN adaptor 352 is a 4G LTE or a 5G NR wireless network adaptor, which can be used for low-latency HD map data retrieval. An example LAN adaptor 353 is an IEEE 802.11 WiFi wireless network adapter. An example PAN adaptor 354 is a Bluetooth wireless network adaptor. Each of adaptors 352, 353, and/or 354 may be coupled to an antenna, including multiple antennas configured for primary and diversity reception and/or configured for receiving specific frequency bands. Autonomous vehicles 115i-115k may further include or be coupled to power supply 318, such as a battery or an alternator. Autonomous vehicles 115i-115k may also include or be coupled to additional features or components that are not shown in FIG. 3. In one example, a wireless interface, which may include one or more transceivers and associated baseband processors, may be coupled to or included in WAN adaptor 352 for a wireless communication device. In a further example, an analog front end (AFE) to convert analog image frame data to digital image frame data may be coupled between the image sensors 301 and 302 and the image signal processor 312.

Autonomous vehicles 115i-115k may include sensor hub 350 for interfacing with sensors to receive data regarding movement of autonomous vehicles 115i-115k, data regarding an environment around autonomous vehicles 115i-115k, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. Such sensors can provide critical data for autonomous navigation and HD map data processing. For example, sensor hub 350 may interface to a vehicle bus for sending configuration commands and/or receiving information from vehicle sensors 372, such as distance (e.g., ranging) sensors or vehicle-to-vehicle (V2V) sensors (e.g., sensors for receiving information from nearby vehicles).

Image signal processor (ISP) 312 may receive image data, such as used to form image frames. In one embodiment, a local bus connection couples image signal processor 312 to image sensors 301 and 302 of first camera 303 and second camera 305. In another embodiment, a wire interface may couple image signal processor 312 to an external image sensor. In a further embodiment, a wireless interface may couple image signal processor 312 to image sensor 301, 302.

First camera 303 may include first image sensor 301 and corresponding first lens 331. Second camera 305 may include second image sensor 302 and corresponding second lens 232. Each of lenses 331 and 332 may be controlled by associated autofocus (AF) algorithm 333 executing in ISP 312, which adjust lenses 331 and 332 to focus on a particular focal plane at a certain scene depth from image sensors 301 and 302. AF algorithm 233 may be assisted by depth sensor 340. In some embodiments, lenses 331 and 232 may have a fixed focus.

First image sensor 301 and second image sensor 302 are configured to capture one or more image frames. Lenses 331 and 332 focus light at image sensors 301 and 302, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, image signal processor 312 may execute instructions from a memory, such as instructions 308 from memory 306, instructions stored in a separate memory coupled to or included in image signal processor 312, or instructions provided by processor 304. In addition, or in the alternative, image signal processor 312 may include specific hardware (such as one or more integrated circuits (ICs)) configured to perform one or more operations described in the present disclosure. For example, image signal processor 312 may include one or more image front ends (IFEs) 335, one or more image post-processing engines (IPEs) 336, and or one or more auto exposure compensation (AEC) 334 engines. AF 333, AEC 334, IFE 335, IPE 336 may each include application-specific circuitry, may be embodied as software code executed by ISP 312, and/or a combination of hardware within and software code executing on ISP 312.

In some implementations, memory 306 may include a non-transient or non-transitory computer readable medium storing computer-executable instructions 308 to perform all or a portion of one or more operations described in this disclosure. In some implementations, instructions 308 include a camera application (or other suitable application) to be executed during operation of autonomous vehicles 115i-115k for generating images or videos. Instructions 308 may also include other applications or programs executed for autonomous vehicles 115i-115k, such as an operating system, mapping applications, or entertainment applications. Execution of the camera application, such as by processor 304, may cause autonomous vehicles 115i-115k to generate images using image sensors 301 and 302 and image signal processor 312. Memory 306 may also be accessed by image signal processor 312 to store processed frames or may be accessed by processor 304 to obtain the processed frames. In some embodiments, autonomous vehicles 115i-115k include a system on chip (SoC) that incorporates image signal processor 312, processor 304, sensor hub 350, memory 306, and input/output components 316 into a single package.

In some embodiments, at least one of image signal processor 312 or processor 304 executes instructions to perform various operations described herein, including object detection, risk map generation, driver monitoring, and driver alert operations. For example, execution of the instructions can instruct image signal processor 312 to begin or end capturing an image frame or a sequence of image frames. In some embodiments, processor 304 may include one or more general-purpose processor cores 304A capable of executing scripts or instructions of one or more software programs, such as instructions 308 stored within the memory 306. For example, processor 304 may include one or more application processors configured to execute the camera application (or other suitable application for generating images or video) stored in memory 306.

In executing the camera application, processor 304 may be configured to instruct image signal processor 312 to perform one or more operations with reference to the image sensors 301 or 302. For example, the camera application may receive a command to begin a video preview display upon which a video comprising a sequence of image frames is captured and processed from one or more image sensors 301 or 302 and displayed on informational display on display 314 in a cabin of the autonomous vehicles 115i-115k.

In some embodiments, processor 304 may include ICs or other hardware (e.g., an artificial intelligence (AI) engine 384) in addition to the ability to execute software to cause autonomous vehicles 115i-115k to perform a number of functions or operations, such as the operations described herein. In some other embodiments, autonomous vehicles 115i-115k do not include processor 304, such as when all of the described functionality is configured in image signal processor 312.

The vision transformer architecture described herein may be implemented using various artificial intelligence (AI) and machine learning (ML) processing components. In some embodiments, the AI engine 384 comprises, e.g., neural network acceleration hardware configured to efficiently process vision transformer operations. This hardware may include tensor processing units (TPUs), neural processing units (NPUs), or other AI-specific integrated circuits optimized for matrix operations and attention mechanism computations characteristic of vision transformers.

The adapter layer training and inference operations may be implemented through various hardware configurations. In some embodiments, the AI engine 384 includes dedicated memory units for storing pretrained model weights, adapter layer parameters, and intermediate computational results. In some embodiments, the engine may employ fixed-point or reduced precision arithmetic units specifically designed for efficient neural network operations while maintaining numerical stability required for the vector comparison metrics described herein.

For autonomous vehicle applications, the vision transformer processing may be distributed across multiple processing elements. For example, some adapter layers may execute on dedicated AI acceleration hardware while others operate on general-purpose processors, with the hardware configuration optimized based on latency requirements and available computational resources. The system may dynamically adjust the distribution of processing tasks between AI-specific and general-purpose hardware based on real-time performance requirements and power constraints.

Beyond autonomous vehicles, the described vision transformer architecture may be implemented in various hardware configurations suited to different applications. For mobile devices, described architectures may utilize mobile AI accelerators optimized for power efficiency while maintaining real-time processing capabilities. In data center implementations, the system may leverage specialized AI processing cards or clusters of AI accelerators to handle high-throughput vision transformer operations across multiple simultaneous streams.

The AI engine 384 may include hardware-specific optimizations for the token processing operations. This may include dedicated circuitry for patchify operations, memory access patterns for efficient token manipulation, and hardware-accelerated implementation of the vector comparison metrics used during adapter layer training. The engine may also include monitoring circuits that track processing accuracy and latency to inform adaptation of the model architecture.

In some embodiments, the system includes hardware support for both training and inference operations. This may include specialized circuits for computing gradients during adapter layer training, while maintaining fixed parameters for the pretrained portions of the model. The hardware may implement efficient data paths for the two distinct processing modes of generating output vectors with and without classification tokens, enabling the controlled-invariance training approach described herein.

In some embodiments, display 314 may include one or more suitable displays or screens allowing for user interaction and/or to present items to the user, such as a preview of the image frames being captured by image sensors 301 and 302. In some embodiments, display 314 is a touch-sensitive display. I/O components 316 may be or include any suitable mechanism, interface, or device to receive input (such as commands) from the user and to provide output to the user through display 314. For example, I/O components 316 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, I/O components 316 may include an interface to a vehicle's bus for providing commands and information to and receiving information from vehicle systems 370 including propulsion (e.g., commands to increase or decrease speed or apply brakes) and steering systems (e.g., commands to turn wheels, change a route, or change a final destination).

While shown to be coupled to each other via processor 304, components (such as processor 304, memory 306, image signal processor 312, display 314, and I/O components 316) may be coupled to each another in other various arrangements, such as via one or more local buses, which are not shown for simplicity. While image signal processor 312 is illustrated as separate from processor 304, image signal processor 312 may be a core of processor 304 that is an application processor unit (APU), included in a system on chip (SoC), or otherwise included with processor 304. While autonomous vehicles 115i-115k are referred to in the examples herein for including aspects of the present disclosure, some device components may not be shown in FIG. 3 to prevent obscuring aspects of the present disclosure. Additionally, other components, numbers of components, or combinations of components may be included in suitable autonomous vehicles for performing aspects of the present disclosure. As such, the present disclosure is not limited to a specific device or configuration of components, including autonomous vehicles 115i-115k.

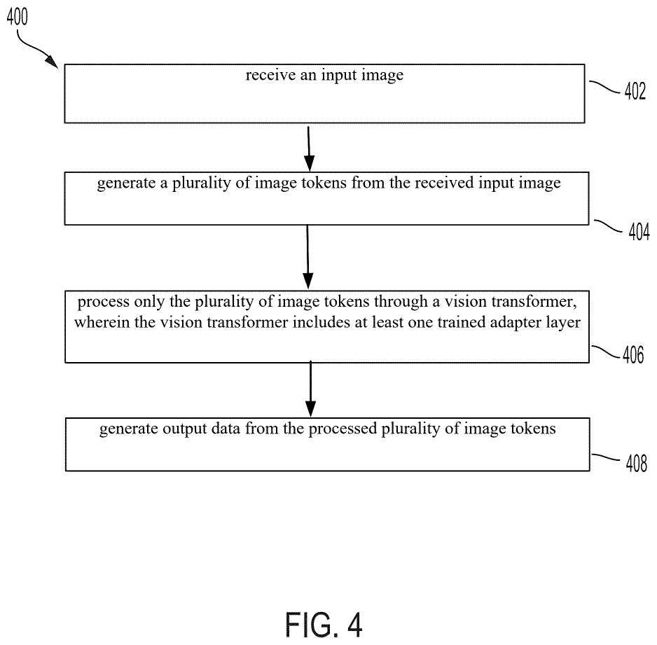

FIG. 4 shows a flowchart illustrating a method 400 performable by an apparatus that supports efficient vision transformer operations according to aspects described herein. The operations of method 400 may be implemented by an apparatus incorporating, e.g., neural network hardware and processing capabilities as described herein. For example, the method 400 may be performed by an apparatus incorporating an AI engine 384 and associated processing components described with reference to FIG. 3, configured for vision transformer operations. In some examples, the method 400 may be performed by a processor 304 working in conjunction with AI engine 384 and associated hardware accelerators.

At step 402, the apparatus receives an input image. The image may be received via image sensors 301/302, processed through image signal processor 312, or accessed from memory 306. The processor 304, working with AI engine 384, prepares the input data for transformer processing.

At step 404, the apparatus generates a plurality of image tokens from the received input image. At step 404, the processor 304 and AI engine 384 employ circuitry configured for, e.g., patchify operations, converting the input image into a sequence of learned token representations. The hardware in AI engine 384 enables efficient token generation through optimized memory access patterns specifically designed for vision transformer operations.

At step 406, the apparatus processes only the plurality of image tokens through a vision transformer that includes at least one trained adapter layer. The processor 304 coordinates with AI engine 384 to execute the transformer operations, leveraging tensor processing units and neural accelerators specifically optimized for attention mechanisms and matrix computations. By processing only image tokens, the apparatus achieves factorizable dimensions that map efficiently to the hardware accelerators, avoiding the computational overhead associated with unnecessary supplemental token processing.

In some implementations, the transformer comprises multiple transformer layers that each maintain fixed parameters during operation. This approach preserves the pretrained model characteristics while enabling targeted adaptation through the adapter layers. The fixed parameter approach significantly reduces computational overhead compared to full model retraining, and therefore, is particularly beneficial in resource-constrained environments.

At step 408, the apparatus generates output data from the processed plurality of image tokens. Step 408 can be performed through, e.g., coordinated operation of processor 304 and AI engine 384. The hardware enables efficient generation of the output representations suitable for downstream processing tasks.

In particular implementations, according to method 400, the apparatus can merge the trained adapter layer with a downstream processing adapter layer through its hardware-accelerated data paths. In this way, merging optimizes computational efficiency by folding the adapter layer into existing processing stages without introducing additional compute overhead. According to processor 400, the apparatus may employ learnt patchify parameters from the pretrained transformer, which enables efficient token generation while maintaining model accuracy.

For implementations requiring accuracy monitoring, an apparatus operating according to method 400 can utilize vector comparison metrics between output sets—one comprising image token outputs with a supplemental token output, and another comprising only image token outputs. This controlled-invariance approach enables the apparatus to maintain model accuracy while achieving processing efficiency. When accuracy measurements indicate adjustments are needed, the apparatus can incorporate additional adapter layers while maintaining the efficiency benefits of the token-focused processing strategy.

The method 400 may include mathematical difference calculations between the image token outputs from both vector sets, providing quantitative metrics for adaptation decisions. This approach enables an apparatus operating according to method 400 to balance processing efficiency with model performance, particularly crucial in autonomous vehicle applications where real-time processing demands must be met while maintaining high accuracy standards.

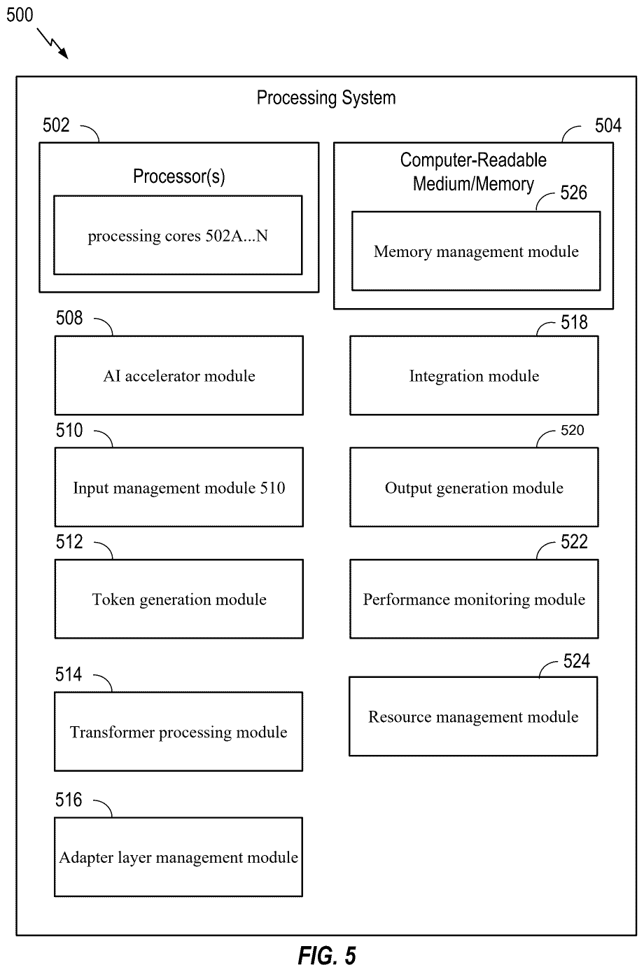

FIG. 5 shows an apparatus 500 that can implement vision transformer operations with selective token processing. The apparatus 500 can be implemented using components described with reference to FIG. 3, including, e.g., processor 304 and/or AI engine 384, and can be configured to perform operations associated with method 400 described above.

The apparatus 500 includes processor 502 coupled to memory 504 through system bus 506. The processor 502 can incorporate multiple processing cores 502A-N configured to handle parallel processing streams for vision transformer operations. As discussed, an AI accelerator module 508 can provide specialized capabilities for transformer attention mechanisms and token relationship analysis.

Input management module 510 can be configured to receive and coordinate image data flow through various hardware interfaces. The input data may arrive directly from image sensors, from memory 504, or through standard network interfaces. Module 510 can include dedicated synchronization circuits for temporal alignment and configurable DMA controllers to enable efficient data movement between input buffers and processing stages.

Token generation module 512 can be configured to implement patchify operations for converting input images into token representations. Multiple parallel processing elements within block 512 can transform image regions into standardized token formats suitable for transformer processing. The module can include dedicated token generation accelerators that adapt to varying input characteristics and viewing conditions. Also, caching mechanisms can maintain rapid access to patchify parameters.

Transformer processing module 514 can be configured to process only image tokens through transformer layers while maintaining fixed parameters. It can employ parallel attention pipelines that preserve token relationships during processing. Associated hardware can support sophisticated attention operations with memory controllers managing token interactions from multiple sources. Implementations can include hardware-assisted validation mechanisms that ensure processing consistency.

Adapter layer management module 516 can be configured to selectively incorporate and train adapter layers within the transformer architecture based on accuracy measurements. The module 516 can, e.g., maintain processing units that can evaluate model performance and add adapter layers where needed to optimize accuracy while preserving computational efficiency. Through accuracy monitoring, module 516 enables dynamic adaptation that balances performance requirements and processing overhead

Integration module 518 can be configured to merge trained adapter layers with downstream processing components. In some implementations, module 518 can involve hardware elements—e.g.—dedicated arithmetic units can accelerate integration computations while dedicated circuits maintain processing consistency. Arbitration mechanisms can manage access to shared resources and hardware-assisted validation can ensure integration accuracy.

Output generation module 520 can be configured to produce processed data from transformed tokens. It can include dedicated processing units for formatting and delivering outputs according to different application requirements. Hardware-assisted validation mechanisms associated with block 520 can ensure output consistency while dedicated memory controllers manage efficient data transfer to downstream applications.

Performance monitoring module 522 can be configured to track processing metrics across the transformer architecture. Multiple monitoring circuits associated with module 522 can be configured to assess computational requirements, thermal conditions, and processing loads in real-time. Further, module 522 can include dedicated hardware elements for continuous accuracy assessment and resource utilization tracking.

Resource management module 524 can be configured to coordinate system-wide operations. The module can implement configurable clock domains for each processing block to enable granular power management. For example, Direct Memory Access (DMA) engines associated with module 524 can, in some instances, manage high-speed data transfers between processing stages while hardware synchronization mechanisms maintain processing coherence.

Memory management module 526 that can be configured to optimize data flow throughout the processing pipeline. The module can implement multiple cache levels and buffers to support efficient data sharing between processing stages. Advanced arbitration schemes within block 526 can manage access to shared resources while maintaining processing priorities.

The foregoing architecture can incorporate additional coordination mechanisms across processing blocks. For example, hardware-assisted quality monitoring can ensure data integrity throughout the token processing pipeline. Validation circuits can verify processing accuracy while maintaining operational efficiency. The implementation can include configurable feedback paths that enable dynamic resource allocation based on processing requirements. Through operation of these the foregoing modules, apparatus 500 can achieve efficient vision transformer processing while maintaining accuracy through controlled adaptation. Multiple processing cores 502A-N can operate in parallel to handle complex transformer operations while hardware accelerators optimize key computations throughout the processing pipeline. Further, the architecture enables flexible deployment of adapter layers while preserving pretrained model capabilities. Quality-of-service controls implemented across processing blocks can maintain operation priorities, while sophisticated arbitration mechanisms manage access to shared computational resources.

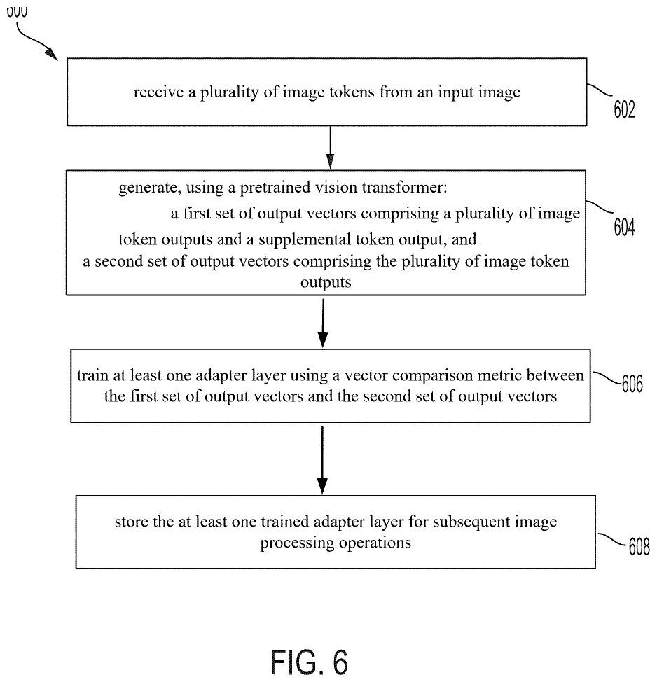

FIG. 6 shows a flowchart illustrating a method 600 performable by an apparatus that supports training of efficient vision transformer models according to aspects described herein. The training can involve, e.g., controlled-invariance approaches that enable efficiency gains while preserving model accuracy. The method 600 may be implemented by an apparatus incorporating neural network training capabilities, including, e.g., AI engine 384 and associated processing components, e.g., processor 304, detailed in FIG. 3.

At step 602, the apparatus receives a plurality of image tokens from an input image. The tokenization hardware efficiently processes input data arriving through multiple possible pathways—directly capture via image sensors 301/302, preprocessing through image signal processor 312, or retrieval from memory 306. Step 602 leverages the pretrained transformer's understanding of visual information and establishes a foundation for subsequent optimization steps.

At step 604, the apparatus generates, using a pretrained vision transformer: a first set of output vectors comprising a plurality of image token outputs and a supplemental token output, and a second set of output vectors comprising the plurality of image token outputs. Through coordinated operation of, e.g., processor 304 and AI engine 384, the distinct vector sets capture the essential model behaviors both with and without supplemental token processing. The generation process maintains control over computational resources while preserving information necessary for effective adaptation.

At step 606, the apparatus trains at least one adapter layer using a vector comparison metric between the first set of output vectors and the second set of output vectors. According to certain implementations, training performed at this step can employ fixed-point arithmetic units to compute differences between corresponding token representations to allow adaptation while maintaining numerical stability. At step 606, hardware such as processor 304 and/or AI engine 384 can work to maintain the pretrained transformer's fixed parameters while adjusting the adapter layer weights according to the computed vector differences.

At step 608, the apparatus stores the at least one trained adapter layer for subsequent image processing operations. According to certain implementations, step 608 can involve saving the adapted parameters to, e.g., memory 306 in a format optimized for rapid retrieval during inference. The apparatus can organize these parameters to maintain alignment with the fixed

Method 600 can extend beyond the foregoing steps through different monitoring and adaptation mechanisms. During operation, an apparatus operating according to method 600 can evaluate the pretrained vision transformer's accuracy using dedicated circuitry within, e.g., AI engine 384. Such monitoring enables dynamic response to performance variations—when measurements indicate the need, the apparatus can seamlessly incorporate additional adapter layers among the transformer layers without disrupting ongoing operations. Throughout this adaptation process, control is maintained over the pretrained transformer's parameters—keeping them fixed to preserve the model's fundamental capabilities while enabling targeted optimization through the adapter layers.

The efficiency of method 600 stems from several different aspects of parameter handling and computational optimization. The vector comparison metric employs mathematical differences between corresponding image token outputs to provide quantitative guidance for the adaptation process. By utilizing, e.g., learnt patchify parameters from the pretrained transformer, an apparatus operating according to method 600 achieves efficient token generation while maintaining high-quality visual information processing. The ability to merge trained adapter layers with downstream processing components creates a streamlined computational pipeline that minimizes overhead while maximizing performance gains.

The foregoing aspects of method 600 are associated with remarkable practical benefits. The controlled-invariance training approach, combined with the hardware-optimized implementation, enables significant improvements in inference speed. Such gains prove particularly valuable in resource-constrained environments where real-time processing demands must be met without compromising accuracy or reliability. According to method 600, the ability to maintain factorizable dimensions throughout the processing pipeline ensures efficient hardware utilization while preserving the model's essential capabilities.

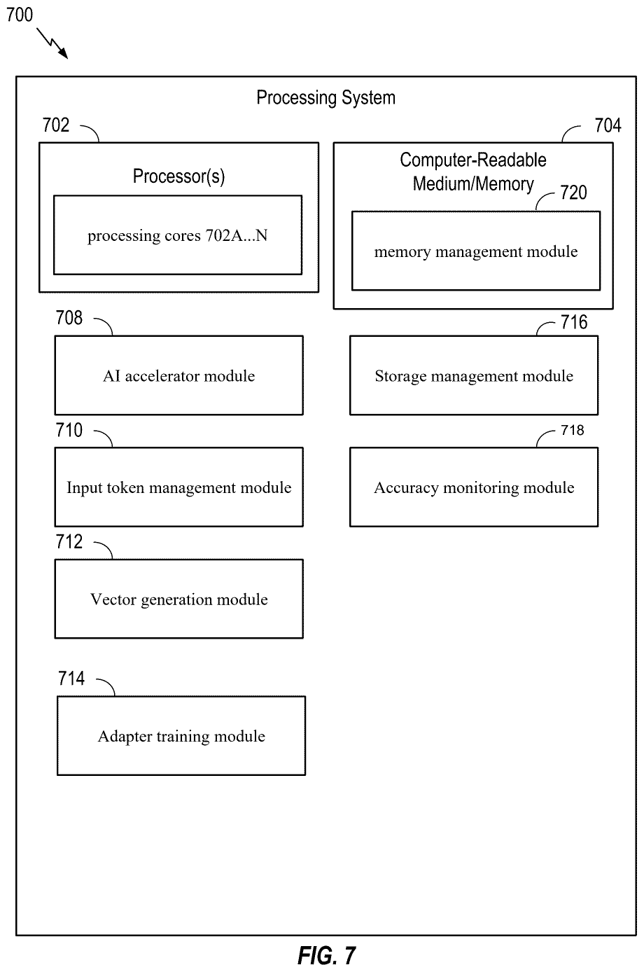

FIG. 7 shows an apparatus 700 that can implement vision transformer training with controlled-invariance adaptation. The apparatus 700 can be implemented using components described with reference to FIG. 3, including, e.g., processor 304 and/or AI engine 384, and can be configured to perform operations associated with method 600 described above.

The apparatus 700 includes processor 702 coupled to memory 704 through system bus 706. The processor 702 can incorporate multiple processing cores 702A-N configured to handle parallel processing streams for vision transformer training operations. As discussed, an AI accelerator module 708 can provide specialized capabilities for vector comparison operations and adapter layer training.

Input token management module 710 can be configured to receive and coordinate image token flow from pretrained vision transformers. The token data may arrive through various pathways—directly from image sensors, from memory 704, or through standard network interfaces. Module 710 can include dedicated synchronization circuits for managing token streams and configurable DMA controllers to enable efficient data movement between processing stages.

Vector generation module 712 can be configured to produce the two distinct sets of output vectors using the pretrained transformer. Multiple parallel processing elements within block 712 can generate both the full token set (including supplemental tokens) and the image-only token set. The module can include dedicated vector generation accelerators that maintain consistent processing across both output paths while preserving transformer parameters.

Adapter training module 714 can be configured to implement the vector comparison metrics and train adapter layers while maintaining fixed transformer parameters. It can employ parallel computation pipelines that efficiently calculate differences between output vector sets. Associated hardware can support sophisticated training operations with memory controllers managing parameter updates across multiple adapter layers.

Storage management module 716 can be configured to handle efficient storage and retrieval of trained adapter layers. In some implementations, module 716 can organize adapter parameters for optimal integration with downstream processing stages. Dedicated memory structures can maintain rapid access to both fixed transformer parameters and adaptable layer weights. Accuracy monitoring module 718 can be configured to track model performance and initiate adapter layer incorporation as needed. Multiple monitoring circuits can assess accuracy metrics in real-time, while dedicated hardware elements manage the dynamic addition of adapter layers within the transformer architecture.

The apparatus incorporates memory management module 720 that can be configured to optimize data flow throughout the training pipeline. The module can implement multiple cache levels and buffers to support efficient parameter sharing between processing stages. Advanced arbitration schemes can manage access to shared resources while maintaining training priorities.

Through operation of these modules, apparatus 700 can achieve efficient vision transformer adaptation while maintaining model accuracy. Multiple processing cores 702A-N can operate in parallel to handle complex training operations while hardware accelerators optimize key computations throughout the processing pipeline. The architecture enables controlled-invariance training through sophisticated vector comparison mechanisms while preserving pretrained model capabilities.

In one or more aspects, techniques for efficient vision transformer processing may include additional aspects, such as any single aspect or any combination of aspects described below or in connection with one or more other processes or devices described elsewhere herein. In a first aspect, an apparatus for processing vision transformer models comprises: a processing system that includes one or more processors and one or more memories coupled with the one or more processors, the processing system configured to: receive an input image for processing; generate a plurality of image tokens from the input image; process only the plurality of image tokens through a vision transformer, wherein the vision transformer includes at least one trained adapter layer; and generate output data from the processed plurality of image tokens. The processing system may be implemented using specialized hardware accelerators, neural processing units, or general-purpose processors configured for efficient vision transformer operations.

Clause 2: The apparatus of Clause 1, wherein the at least one trained adapter layer is merged with a downstream processing adapter layer.

Clause 3: The apparatus of Clause 1, wherein the vision transformer comprises a plurality of transformer layers, and wherein the processor is configured to add one or more additional adapter layers to the plurality of transformer layers according to an accuracy measurement associated with the vision transformer.

Clause 4: The apparatus of Clause 3, wherein the plurality of transformer layers maintain fixed parameters during operation.

Clause 5: The apparatus of Clause 1, wherein processing only the plurality of image tokens comprises omitting supplemental classification tokens from the vision transformer processing.

Clause 6: The apparatus of Clause 1, wherein the processor generates the plurality of image tokens using a patchify operation.

Clause 7: An apparatus comprising: a processor configured to: receive a plurality of image tokens from an input image; generate, using a pretrained vision transformer: a first set of output vectors comprising a plurality of image token outputs and a supplemental token output, and a second set of output vectors comprising the plurality of image token outputs; train at least one adapter layer using a vector comparison metric between the first set of output vectors and the second set of output vectors; and store the at least one trained adapter layer for subsequent image processing operations.

Clause 8: The apparatus of Clause 7, wherein the processor is further configured to: monitor accuracy of the pretrained vision transformer; and incorporate one or more additional adapter layers among a plurality of transformer layers of the pretrained vision transformer responsive to accuracy measurements.

Clause 9: The apparatus of Clause 7, wherein the processor maintains fixed parameters of the pretrained vision transformer while training the at least one adapter layer.

Clause 10: The apparatus of Clause 7, wherein the vector comparison metric comprises a mathematical difference between: the plurality of image token outputs from the first set of output vectors, and the plurality of image token outputs of the second set of output vectors.

Clause 11: The apparatus of Clause 7, wherein the processor generates the plurality of image tokens using learnt patchify parameters from the pretrained vision transformer.

Clause 12: The apparatus of Clause 7, wherein the processor merges the at least one trained adapter layer with a downstream processing adapter layer.

Clause 13: A method comprising: receiving an input image; generating a plurality of image tokens from the input image; processing only the plurality of image tokens through a vision transformer including at least one trained adapter layer; and generating output data from the processed plurality of image tokens.

Clause 14: The method of Clause 13, comprising: merging the at least one trained adapter layer with a downstream processing adapter layer.

Clause 15: The method of Clause 13, wherein the vision transformer comprises a plurality of transformer layers maintaining fixed parameters during operation.

Clause 16: The method of Clause 13, wherein the at least one trained adapter layer comprises an adapter layer trained using a vector comparison metric between: a first set of output vectors comprising a plurality of image token outputs and a supplemental token output, and a second set of output vectors comprising the plurality of image token outputs.

Clause 17: The method of Clause 16, wherein the vector comparison metric comprises a mathematical difference between: the plurality of image token outputs from the first set of output vectors, and the plurality of image token outputs of the second set of output vectors.

Clause 18: The method of Clause 13, wherein generating the plurality of image tokens comprises applying a patchify operation to the input image.

Clause 19: The method of Clause 13, wherein the output data comprises perception data for autonomous vehicle operation.

Clause 20: The method of Clause 13, comprising: monitoring accuracy measurements of the vision transformer; and incorporating one or more additional adapter layers responsive to the accuracy measurements.

Clause 21: An apparatus including: at least one memory including executable instructions; and at least one processor configured to execute the executable instructions and cause the apparatus to perform a method in accordance with any combination of Clauses 1-20.

Clause 22: An apparatus including means for performing a method in accordance with any combination of Clauses 1-20.

Clause 23: A non-transitory computer-readable medium including executable instructions that, when executed by at least one processor of an apparatus, cause the apparatus to perform a method in accordance with any combination of Clauses 1-20.

Clause 24: A computer program product embodied on a computer-readable storage medium including code for performing a method in accordance with any combination of Clauses 1-20.

Clause 25: A processing system, including: at least one processor; at least one memory including instructions; and one or more processors, individually or collectively, configured to: receive an input image; generate a plurality of image tokens from the input image; process only the plurality of image tokens through a vision transformer, wherein the vision transformer includes at least one trained adapter layer; and generate output data from the processed plurality of image tokens.

Clause 26: A training system, including: at least one processor; at least one memory including instructions; and one or more processors, individually or collectively, configured to: receive a plurality of image tokens from an input image; generate, using a pretrained vision transformer: a first set of output vectors comprising a plurality of image token outputs and a supplemental token output, and a second set of output vectors comprising the plurality of image token outputs; train at least one adapter layer using a vector comparison metric between the first set of output vectors and the second set of output vectors; and store the at least one trained adapter layer for subsequent image processing operations.

Clause 27: A method processing system, including: at least one processor; at least one memory including instructions; and one or more processors, individually or collectively, configured to: receive an input image; generate a plurality of image tokens from the input image; process only the plurality of image tokens through a vision transformer including at least one trained adapter layer; and generate output data from the processed plurality of image tokens.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus comprising:
a processor configured to:
receive an input image;
generate a plurality of image tokens from the input image;
process only the plurality of image tokens through a vision transformer, wherein the vision transformer includes at least one trained adapter layer; and
generate output data from the processed plurality of image tokens.

2. The apparatus of claim 1, wherein the at least one trained adapter layer is merged with a downstream processing adapter layer.

3. The apparatus of claim 1, wherein the vision transformer comprises a plurality of transformer layers, and wherein the processor is configured to add one or more additional adapter layers to the plurality of transformer layers according to an accuracy measurement associated with the vision transformer.

4. The apparatus of claim 3, wherein the plurality of transformer layers maintain fixed parameters during operation.

5. The apparatus of claim 1, wherein processing only the plurality of image tokens comprises omitting supplemental classification tokens from the vision transformer processing.

6. The apparatus of claim 1, wherein the processor generates the plurality of image tokens using a standard vision transformer patchify operation, and processes the generated image tokens through the vision transformer without appending a classification token.

7. An apparatus comprising:
a processor configured to:
receive a plurality of image tokens from an input image;
generate, using a pretrained vision transformer:
a first set of output vectors comprising a plurality of image token outputs and a supplemental token output, and
a second set of output vectors comprising the plurality of image token outputs;
train at least one adapter layer using a vector comparison metric between the first set of output vectors and the second set of output vectors; and
store the at least one trained adapter layer for subsequent image processing operations.

8. The apparatus of claim 7, wherein the processor is further configured to:
monitor accuracy of the pretrained vision transformer; and
incorporate one or more additional adapter layers among a plurality of transformer layers of the pretrained vision transformer responsive to accuracy measurements.

9. The apparatus of claim 7, wherein the processor maintains fixed parameters of the pretrained vision transformer while training the at least one adapter layer.

10. The apparatus of claim 7, wherein the vector comparison metric is associated with a difference between:
the plurality of image token outputs from the first set of output vectors, and
the plurality of image token outputs of the second set of output vectors.

11. The apparatus of claim 7, wherein the processor generates the plurality of image tokens using learnt patchify parameters from the pretrained vision transformer.

12. The apparatus of claim 7, wherein the processor merges the at least one trained adapter layer with a downstream processing adapter layer.

13. A method comprising:
receiving an input image;
generating a plurality of image tokens from the input image;
processing only the plurality of image tokens through a vision transformer including at least one trained adapter layer; and
generating output data from the processed plurality of image tokens.

14. The method of claim 13, comprising:
merging the at least one trained adapter layer with a downstream processing adapter layer.

15. The method of claim 13, wherein the vision transformer comprises a plurality of transformer layers maintaining fixed parameters during operation.

16. The method of claim 13, wherein the at least one trained adapter layer comprises an adapter layer trained using a vector comparison metric between:
a first set of output vectors comprising a plurality of image token outputs and a supplemental token output, and
a second set of output vectors comprising the plurality of image token outputs.

17. The method of claim 16, wherein the vector comparison metric comprises a mathematical difference between:
the plurality of image token outputs from the first set of output vectors, and
the plurality of image token outputs of the second set of output vectors.

18. The method of claim 13, wherein generating the plurality of image tokens comprises applying a patchify operation to the input image.

19. The method of claim 13, wherein processing only the plurality of image tokens comprises discarding supplemental classification tokens prior to vision transformer processing.

20. The method of claim 13, comprising:
monitoring accuracy measurements of the vision transformer; and
incorporating one or more additional adapter layers responsive to the accuracy measurements.
